(19) United States
(12) Patent Application Publication
(10) Pub. No.: US 2002/0040652 A1
(43) Pub. Date: Apr. 11, 2002

(54) Process for creating a printing form

(76) Inventor: Arndt Jentzsch, Coswig (DE)

Correspondence Address: GABRIEL P. KATONA, GOODWIN PROCTER L.L.P., 599 LEXINGTON AVENUE, 40TH FLOOR, NEW YORK, NY, 10022, US

(21) Appl. No.: 09/924,160

(22) Filed: Aug. 7, 2001

(30) Foreign Application Priority Data
Aug. 9, 2000 (DE) 100 39 819.7

(51) Int. Cl. B41C 1/00; B41N 6/00

(52) U.S. Cl. 101/401.1

(57) ABSTRACT

The invention relates to a process for creating an image carrying printing form on a printing form cylinder in a printing press.

Task of the invention is to realize a process for creating an erasable printing form on a printing form cylinder in a printing press with low expenditures and high life time.

The task is solved according the invention by the printing cylinder having a semiconductor surface, the semiconductor surface being image carrying polarized, coated with toner on the image carrying areas and the toner compacted with printing form cylinder. The so created printing form is used for printing. The toner compacted with the printing form cylinder is removed by a laser after printing.

### FIELD OF INVENTION

The invention relates to a process for creating an image carrying printing form on a printing form cylinder in a printing press.

### BACKGROUND OF INVENTION

A process for creating a printing form for offset printing presses, especially for presses with a dampening unit, with water repelling ink receptive image areas and water receptive, the affinity to water influencing areas are known by DE 4119111 A1. An oil receptive water resistant coating medium is created in dots are matrixes by droplets from at least one nozzle connected to a reservoir and layered on parts of the water receptive surface of a printing form cylinder. The nozzle is moved in line direction and the printing form cylinder perpendicular to this direction. A central control unit receives digital image information from an information storage and transmits the control signals through a transfer unit and a control unit to the nozzle and the printing form cylinder.

Furthermore the Xerox copy process is well known. This copy process creates a latent image on a semiconductor cylinder. This image is transferred with a powdered toner to the paper sheet and the latent image is erased. This process can not be used in printing presses.

### SUMMARY DESCRIPTION OF INVENTION

Task of the invention is to realize a process for creating an erasable printing form on a printing form cylinder in a printing press with low expenditures and high life time.

The task is solved according the invention by the printing cylinder having a semiconductor surface, the semiconductor surface being image carrying polarized, coated with toner on the image carrying areas and the toner compacted with printing form cylinder. The so created printing form is used for printing. The toner compacted with the printing form cylinder is removed by a laser after printing.

### BRIEF DESCRIPTION OF THE DRAWING

The invention is described below in greater detail by an embodiment of the invention, by reference being had to the drawing, wherein:

FIG. 1: Printing form cylinder with erasing device

FIG. 2: Printing form cylinder with polarization device

FIG. 3: Printing form cylinder with application device for a toner

FIG. 4: Printing form cylinder with compacting device

### DETAILED DESCRIPTION

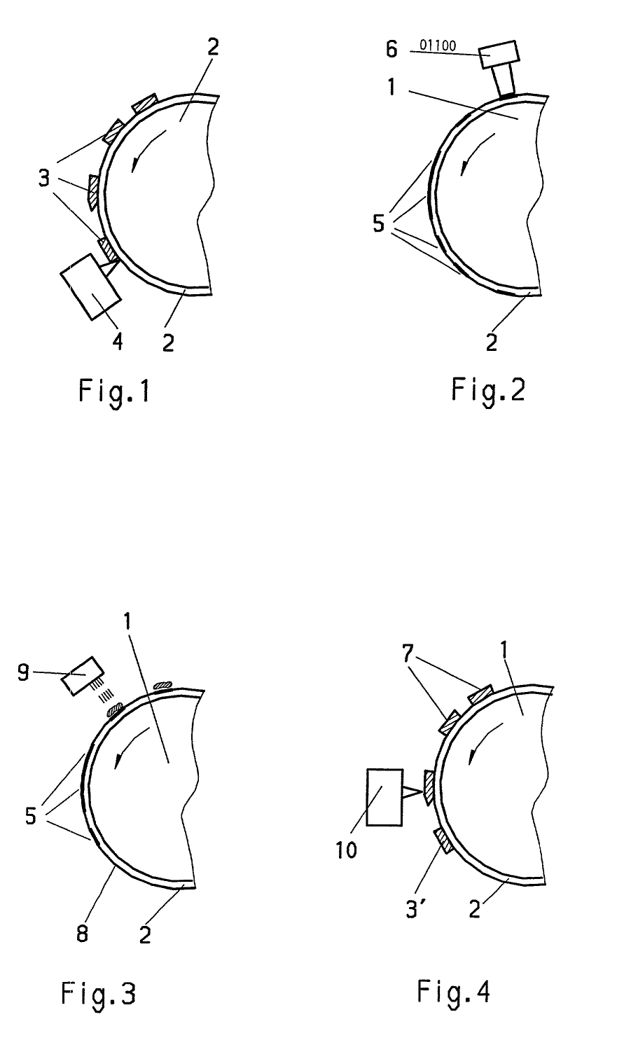

FIG. 1 shows a printing form cylinder in a printing press. The printing form cylinder 1 has a semiconductor surface 2 appropriately with water receptive characteristic.

The semiconductor surface 2 has image carrying areas 3 from the preceding printing job. These areas are water repelling.

Before new image carrying areas 3′ can be applied to the printing form cylinder 1 the image carrying areas 3 of the preceding printing job must be erased. This image carrying areas 3 of the preceding printing job are erased by an erasing device 4 allocated to the printing form cylinder 1. The erasing device 4 operates with the laser principle. It traverses over the width of the printing form cylinder 1 or stretches over the entire width of the printing form cylinder 1.

FIG. 2 shows the process step polarization of the new image carrying areas 3′ of the semiconductor surface 2. The new image carrying areas 3′ of the new printing job are polarized with the polarization device 6. The polarization makes the polarized areas 5 receptive for the later applied toner 7. The polarization device 6 has a not shown storage device for digital matrix of the image carrying areas. The polarization device 6 traverses like the erasing device 4 or stretches over the entire width of the printing form cylinder 1.

In a further processing step shown in FIG. 3 the toner 7 is applied to the semiconductor surface 2 of the printing form cylinder 1. The toner 7 is preferably powdered, but can also be pasty or liquid. The toner 7 sticks to the polarized areas 5 but not at the non-polarized areas 8, which will stay free of toner 7. The toner application device 9 applies the toner 7. This device traverses like the polarization device 6 or stretches over the entire width of the printing form cylinder 1.

FIG. 4 shows the last process step. A compacting device 10 compacts the toner particles sticking to the polarized areas 5. The compacted toner particles are now identical with image carrying areas 3′.

The printing form is ready for printing after this process step.

We claim:

1. Process for creating an image carrying printing form on a printing form cylinder in a printing press
whereby
the printing form cylinder has a semiconductor surface
the semiconductor surface is polarized, coated with toner on the image carrying areas and the toner compacted with the printing form cylinder,
the created printing form is used for printing and
the toner compacted with the printing form cylinder is erased through laser after printing.

2. Process for creating an image carrying printing form on a printing form cylinder according to claim 1
whereby the toner is of powdered, pasty or liquid consistency.

3. Process for creating an image carrying printing form on a printing form cylinder according to claim 1
whereby the toner is burnt in.

4. Process for creating an image carrying printing form on a printing form cylinder according to claim 1
whereby the toner is compacted.
